(19) United States
(12) Patent Application Publication
(10) Pub. No.: US 2025/0229283 A1
(43) Pub. Date: Jul. 17, 2025

(54) POWERED LIQUID SPRAYER

(71) Applicant: MILWAUKEE ELECTRIC TOOL CORPORATION, Brookfield, WI (US)

(72) Inventors: Jonathan S. Pinske, Pewaukee, WI (US); Jeremy A. Schmittinger, Waukesha, WI (US)

(21) Appl. No.: 18/695,569

(22) PCT Filed: Oct. 21, 2022
(86) PCT No.: PCT/US2022/047388

§ 371 Date: Mar. 26, 2024

Related U.S. Application Data
(60) Provisional application No. 63/270,834, filed on Oct. 22, 2021.

(51) Int. Cl. B05B 9/08; B05B 15/60

(52) U.S. Cl. CPC B05B 9/0861; B05B 15/60

(57) ABSTRACT

A portable, battery-powered liquid sprayer includes a supply tank assembly, a body assembly, a battery, and a wand. The supply tank assembly holds a liquid to be sprayed. The body assembly is selectively coupled to and supported by the supply tank assembly. The body assembly receives a motor and a pump. The battery is removably coupled to the body assembly and is operable to supply power to the motor. The wand is moveable relative to the body assembly and is in fluid communication with the supply tank assembly. The wand includes a nozzle, and the wand is operable to activate the motor, which drives the pump to pump the liquid from the supply tank assembly to eject the liquid from the nozzle.

### CROSS-REFERENCE TO RELATED APPLICATIONS

This application claims benefit of U.S. Provisional Patent Application No. 63/270,834, filed Oct. 22, 2021, the entire contents of which are hereby incorporated by reference.

### FIELD

The present disclosure relates generally to liquid sprayers, and more specifically to portable battery-powered liquid sprayers.

### BACKGROUND

Hand-held chemical sprayers are used to spray or otherwise discharge a liquid agent onto an object. Sprayers typically transfer the liquid agent from a reservoir to the object using a pump, a vacuum, or any other device that is capable of creating a pressure differential between the reservoir and a region outside the reservoir, thereby urging the liquid agent to the region outside the reservoir. The liquid agent can be any number of liquid agents including pesticides, fertilizers, insecticide, termiticide, germicide, or other chemical agents.

### SUMMARY

The present disclosure provides, in one independent aspect, a portable, battery-powered liquid sprayer including a supply tank assembly for holding a liquid to be sprayed, a body assembly selectively coupled to and supported by the supply tank assembly, the body assembly receiving a motor and a pump, a battery removably coupled to the body assembly and operable to supply power to the motor, and a wand moveable relative to the body assembly and in fluid communication with the supply tank assembly. The wand includes a nozzle, and the wand is operable to activate the motor, which drives the pump to pump the liquid from the supply tank assembly to eject the liquid from the nozzle.

The present disclosure provides, in another independent aspect, a portable, battery-powered liquid sprayer including a supply tank assembly for holding a liquid to be sprayed, a body assembly coupled to the supply tank assembly, the body assembly including a motor and a pump, a battery removably coupled to the body assembly and operable to supply power to the motor to drive the pump, and a wand in fluid communication with the supply tank assembly. The wand includes a nozzle, a mechanical valve assembly, a handle, a micro switch disposed within the handle, and a trigger movably coupled to the handle. The trigger is moveable to actuate both the mechanical valve assembly and the micro switch, and actuation of the micro switch energizes the motor.

The present disclosure provides, in another independent aspect, a method of storing a portable, battery-powered liquid sprayer in a five-gallon bucket. The method includes maintaining a connection between a body assembly and a supply tank assembly, removing a battery from the body assembly, and placing a wand in a first docking station that extends between the body assembly and the supply tank assembly, such that the wand is held in a substantially vertical position relative to a ground surface. The method further includes positioning the sprayer in the five-gallon bucket, such that the body assembly and the supply tank assembly are completely encompassed within the bucket, while at least a portion of the wand extends beyond the confines of the bucket.

Other features and aspects of the disclosure will become apparent by consideration of the following detailed description and accompanying drawings.

### BRIEF DESCRIPTION OF THE DRAWINGS

FIG. 1 illustrates a side view of a sprayer in accordance with an embodiment of the disclosure, illustrating a wand in a first storage position.

FIG. 2 is a perspective view of the sprayer of FIG. 1, illustrating the wand in a second storage position.

FIG. 3A is a partially exploded view of a tank assembly of the sprayer of FIG. 1.

FIG. 3B is an exploded cross-sectional view of the sprayer, illustrating a check valve assembly of the tank assembly.

FIG. 4 is a bottom perspective view of a body assembly of the sprayer of FIG. 1 with the tank assembly removed, illustrating a motor, a pump, and a controller.

FIG. 5 is a perspective view of the sprayer of FIG. 1 with the wand removed.

FIG. 6 is a side view of a user interface module of the sprayer of FIG. 1.

FIG. 7 is a perspective view of the wand of the sprayer of FIG. 1.

FIG. 8 is an enlarged perspective view of the wand of FIG. 7 with a portion of the wand removed.

FIG. 9 is a cross-sectional view of the wand of FIG. 8.

FIG. 10 is a perspective view of the sprayer of FIG. 1 positioned in a standard five-gallon bucket.

FIG. 11 is a side view of the sprayer of FIG. 1, illustrating external dimensions of the sprayer.

FIG. 12 is a front view of the sprayer of FIG. 1, illustrating external dimensions of the sprayer.

FIG. 13 depicts the sprayer of FIG. 1 being carried by hand, illustrating a center of gravity of the sprayer.

Before any embodiments of the disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

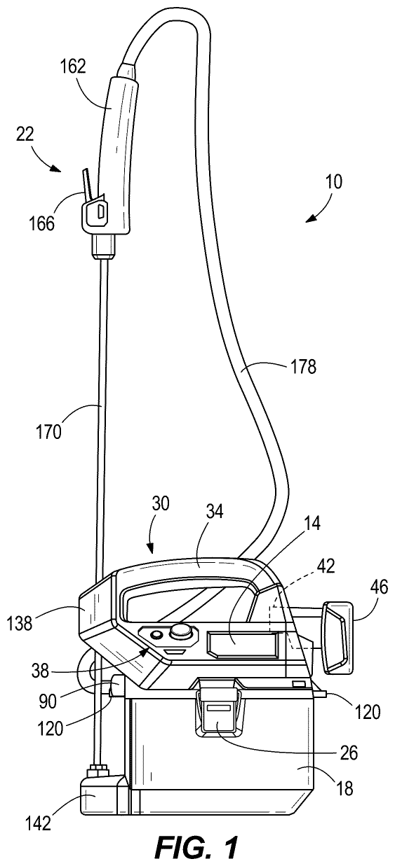

FIG. 1 illustrates a portable, battery-powered sprayer 10 (hereinafter simply referred to as a “sprayer”). In the illustrated embodiment, the sprayer 10 is operable to distribute a liquid solution (e.g., water, pesticides, fertilizers, insecticide, termiticide, germicide, or a mixture of water and some chemical agent) onto a surface or an object such as vegetation.

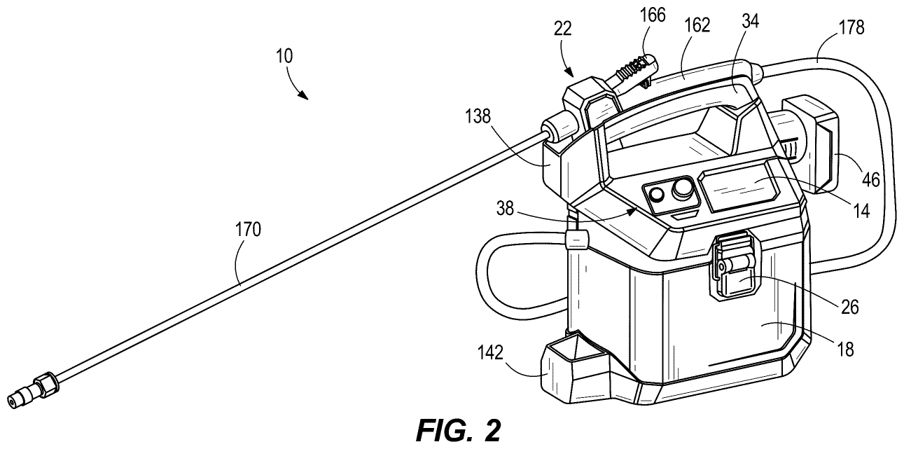

With reference to FIGS. 1 and 2, the illustrated sprayer 10 includes a body assembly 14, a supply tank assembly 18 for storing the liquid solution, and a wand 22 in fluid communication with the supply tank assembly 18 and removably coupled to the body assembly 14. Generally, the body assembly 14 includes a carrying handle 30 having a gripping region 34 for a user to grasp while maneuvering the sprayer 10, a user interface module 38, and a battery receptacle 42 for receiving a battery 46 that provides electrical power to the sprayer 10.

The supply tank assembly 18 is removably coupled to the body assembly 14 via a quick-release mechanism 26. The quick-release mechanism 26 of the illustrated embodiment includes an over-center buckle-type latch. In other embodiments, the quick-release mechanism 26 may alternatively include one or more cam-style levers, turn-knobs, or other quick-release style devices permitting tool-free attachment and detachment of the supply tank assembly 18 to and from the body assembly 14.

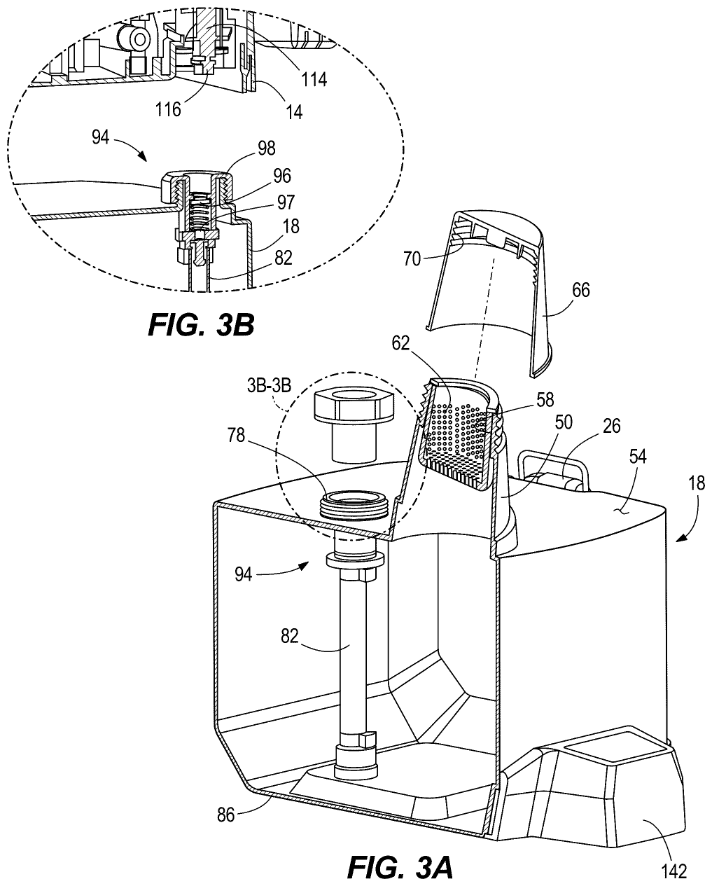

With reference to FIG. 3, the supply tank assembly 18 includes a monolithic container with a cylindrical filling channel 50 extending upward from a top surface 54 of the tank assembly 18 for adding the liquid solution into the tank assembly 18. The filling channel 50 includes an inlet opening 58 that allows liquid to pass through into the tank assembly 18, a filter 62 to inhibit debris or other large particles from entering the tank assembly 18 through the inlet opening 58, and a measuring cup 66 that is threadably coupled to the filling channel 50. Specifically, the measuring cup 66 includes threads 70 on the inner periphery of the measuring cup 66 that mesh with corresponding threads 74 on the outer periphery of the filling channel 50 adjacent the inlet opening 58. The measuring cup 66 is moveable between a first state, in which the measuring cup 66 is coupled to the filling channel 50 to seal the inlet opening 58, and a second state, in which the measuring cup 66 is uncoupled from the filling channel 50 so that a user may measure an amount of chemicals or the like prior to placing the chemicals in the tank assembly 18 (e.g., to ensure an appropriate ratio of chemicals to water when preparing a liquid solution).

With continued reference to FIGS. 3A and 3B, the supply tank assembly 18 further includes an outlet opening 78 disposed at the top surface 54 of the tank assembly 18. The outlet opening 78 receives a pickup line 82 and extends between the outlet opening 78 and a bottom surface 86 of the tank assembly 18 so that the pickup line 82 can draw liquid solution from the bottom surface 86 of the tank assembly 18. A check valve assembly 94 is coupled to the pickup line 82 to selectively enable fluid flow through the pickup line 82. Also, a cap 98 is threadably coupled to the outlet opening 78, enabling a user to remove the cap 98, the pickup line 82, and the check valve assembly 94 (e.g., for maintenance and cleaning purposes). As illustrated in FIG. 3B, the check valve assembly 94 is disposed within the cap 98 and includes a valve 96 and a spring 97 that biases the valve 96 upward toward a closed position. The check valve assembly 94 is moveable between the closed position (FIG. 3B) to an open position. In the closed position, the valve 96 seals against the cap 98 to inhibit liquid solution in the supply tank assembly 18 from inadvertently escaping. In the open position, the valve 96 no longer seals against the cap 98, thereby permitting liquid solution to flow out of the fluid supply tank 18, as explained in further detail below.

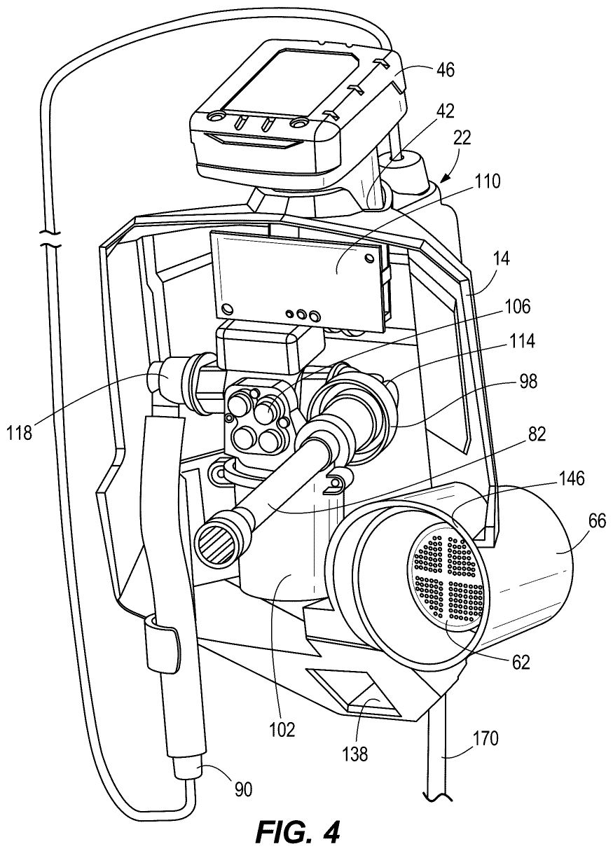

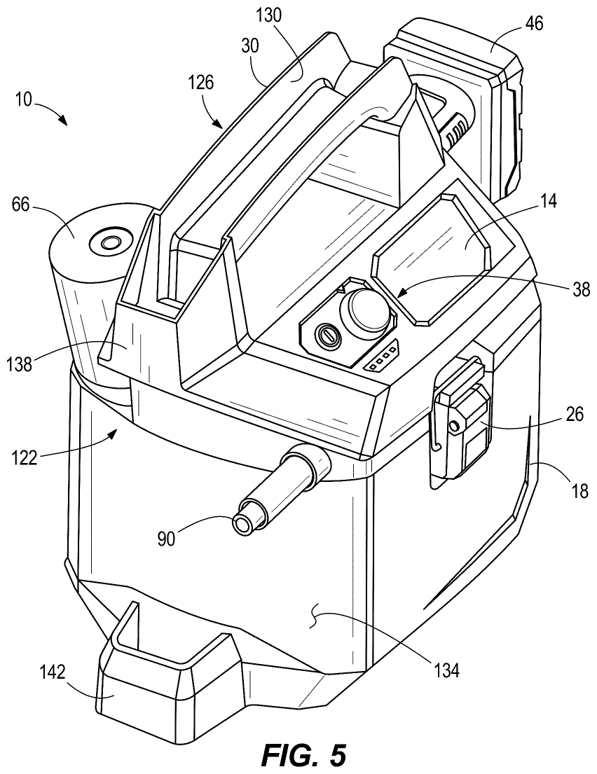

With reference to FIG. 4, the body assembly 14 houses an electric motor 102 (e.g., a brushed or brushless DC motor) that receives electrical power from the battery 46, a pump 106 driven by the motor 102, and a printed circuit board or “PCB” 110 for controlling various aspects of the sprayer 10. The pump 106 (e.g., an impeller pump, centrifugal pump, positive displacement pump, etc.) is driven by the motor 102 and includes an inlet port 114 that draws the liquid solution into the pump 106 and an outlet port 118 that directs pressurized liquid solution away from the pump 106. Specifically, the inlet port 114 is selectively received within the cap 98 of the supply tank assembly 18, such that the inlet port 114 is in fluid communication with the pickup line 82 for drawing liquid solution from the supply tank assembly 18. The inlet port 114 includes a ram 116 (FIG. 3B) that engages and displaces the valve 96 downward against the bias of the spring 97 from the closed position toward the open position when the supply tank assembly 18 is coupled to the body assembly 14. At this point, the check valve assembly 94 is in the open position and the liquid solution is then permitted to travel from the tank assembly 18 and the pickup line 82, through the open check valve assembly 94, and to the pump 106 and the outlet port 118, which directs the liquid solution to a wand port 90 (FIG. 5).

In the illustrated embodiment, the body assembly 14 further includes strap mounts 120 (FIG. 1) extending away from the body assembly 14 and capable of receiving shoulder strap(s) (not shown) so a user can carry the sprayer 10 hands-free. The body assembly 14 also includes a semi-circle cutout 146 (FIG. 4) for accommodating the filling channel 50 and the measuring cup 66. Specifically, the semi-circle cutout 146 in the body assembly 14 allows the filling channel 50 and the measuring cup 66 to extend beyond a portion of the body assembly 14 when the body assembly 14 is coupled to the supply tank assembly 18. As such, a user has access to the filling channel 50 and the measuring cup 66 without removing the body assembly 14 from the supply tank assembly 18.

With reference to FIG. 5, the sprayer 10 further includes a first docking station 122 and a second docking station 126, both of which are capable of receiving and holding at least a portion of the wand 22. The first docking station 122 is disposed adjacent a front surface 134 of the sprayer 10. Specifically, the first docking station 122 includes a first retaining portion 138 disposed at a distal end of the carrying handle 30 and a second retaining portion 142 extending away from the front surface 134 of the sprayer 10 adjacent the bottom surface 86 of the tank assembly 18. A portion of the wand 22 passes through the first retaining portion 138 until the wand 22 engages the second retaining portion 142. Consequently, the wand 22 is carried by the sprayer 10 by the first and second retaining portions 138, 142 when the first docking station 122 receives the wand 22. The second docking station 126 is disposed on the carrying handle 30 and includes a concave slot 130 extending along the length of the carrying handle 30. The concave slot 130 is capable of receiving and holding a portion of the wand 22 to the body assembly 14.

In the illustrated embodiment, the wand 22 is capable of being maneuvered relative to the body assembly 14 when in a detached state. In contrast, the wand 22 can also be maintained in a first storage position, in which the wand 22 is received within the first docking station 122, and a second storage position, in which the wand 22 is received within the second docking station 126. In the first storage position, the wand 22 is simply held upright in the first docking station 122 (FIG. 1). In the second storage position, the wand 22 is held substantially parallel to a ground surface and is coupled (e.g., via press-fit) to the second docking station 126, such that a portion of the concave slot 130 temporarily deforms as the wand 22 is received by the carrying handle 30 to lock the wand 22 in place (FIG. 2).

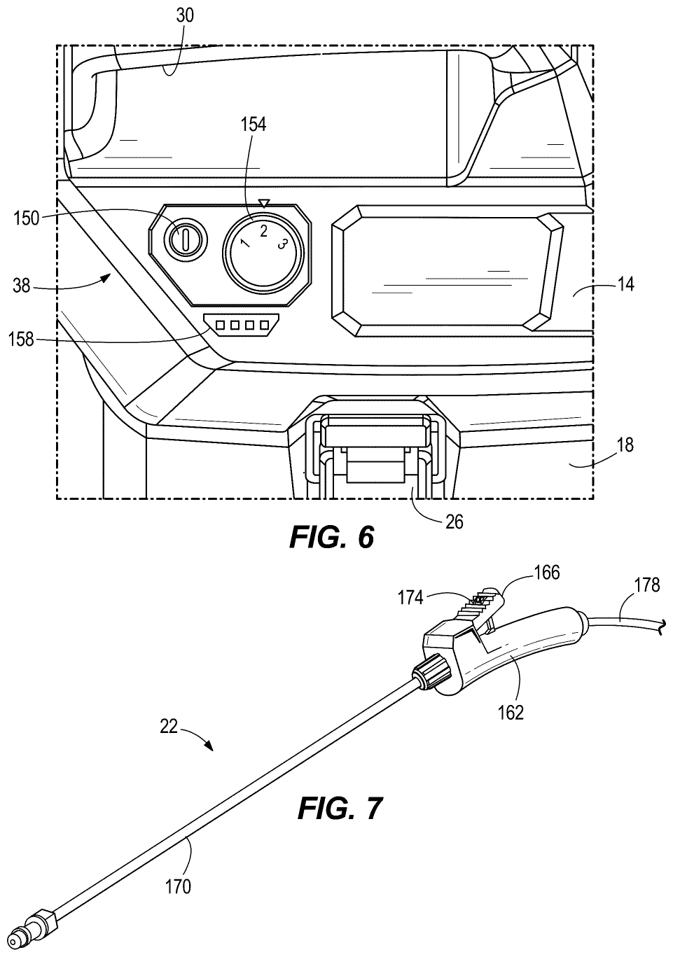

With reference to FIG. 6, the user interface module or “UI module” 38 is disposed on the body assembly 14, while in other embodiments, the UI module 38 may alternatively be disposed on the wand 22. The UI module 38 enables a user to change various settings and monitor the operation of the sprayer 10. Specifically, the UI module 38 includes a power button 150 that is operable to electrically connect the battery 46 with the PCB 110 and the motor 102, a control knob 154, and a power level indicator 158 for displaying the remaining life (i.e., electrical charge) of the battery 46. The control knob 154 is manipulable to vary the voltage and/or current supplied to the motor 102, in order to regulate the pressure and/or the flow rate of the liquid solution ejected from the wand 22 during operation of the sprayer 10. For example, in the illustrated embodiment, the power control knob 154 is adjustable between three different operational positions, so that three different voltages (i.e., corresponding to three different motor speeds) may be supplied to the motor 102 which vary between a first, lowest voltage and a third, highest voltage, thereby providing the sprayer with three different pressures and/or flow rates. In other embodiments, the control knob 154 may be adjustable between fewer or more than three positions and corresponding voltages. In the illustrated embodiment, at least a portion of the UI module 38, in particular, the power level indicator 158, is illuminated by light-emitting diodes (LEDs) to provide a visual feedback to a user.

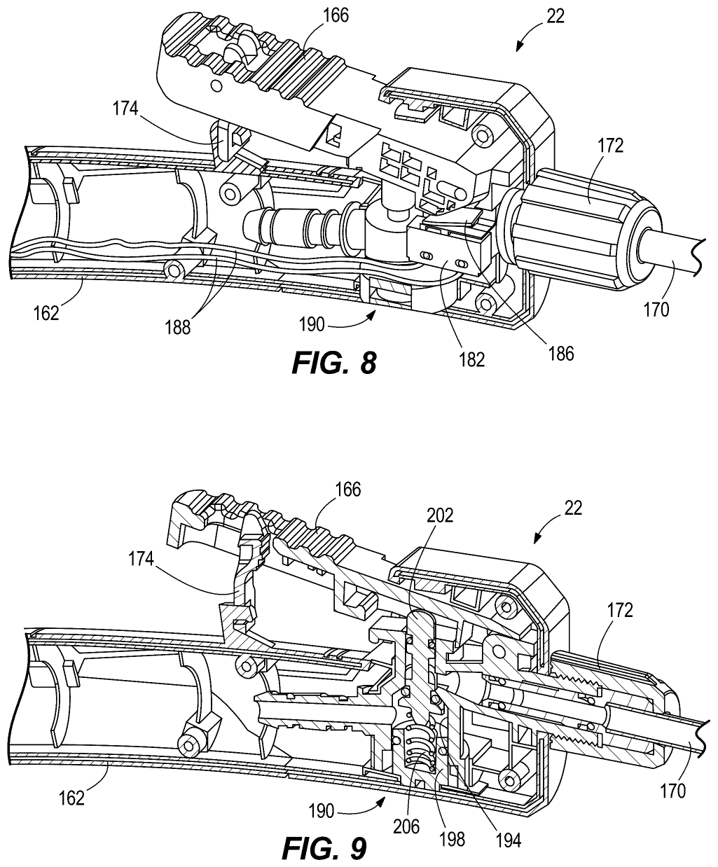

With reference to FIGS. 7-9, the wand 22 includes a wand handle 162 for a user to grasp while holding and maneuvering the wand 22, an actuator or trigger 166 disposed adjacent the wand handle 162 that is depressible to distribute the liquid solution from the wand 22, and a nozzle 170 that extends away from the wand handle 162 and used to direct the liquid solution directly to the object. The nozzle 170 has an extended shaft and a tip and is removably coupled to the wand handle 162 via a threaded collar 172 (FIG. 8). The wand 22 further includes a trigger lock 174 extending from the wand handle 162. When the trigger 166 is depressed, the trigger lock 174 may be moved from an unlocked position to a locked position to keep the trigger 166 depressed, such that a user is not required to continue depressing the trigger 166 when distributing the liquid solution. The wand 22 further includes a flexible hose 178 disposed between the wand handle 162 of the wand 22 and the wand port 90 of the body assembly 14. That is, the wand 22 is in fluid communication with the pump 106 via the hose 178, the pickup line 82, and the supply tank assembly 18.

When the wand 22 is in the first storage position (FIG. 1), the nozzle 170 is received within the first and second retaining portions 138, 142 of the first docking station 122, whereas the wand handle 162 is received within the concave slot 130 of the second docking station 126 when the wand 22 is in the second storage position (FIG. 2).

With reference to FIGS. 7-9, activation and deactivation of the motor 102 is controlled by the trigger 166 of the wand 22. A micro switch 182 (FIG. 8) is located within the wand handle 162 and includes a lever 186 to mechanically amplify a distance traveled by the trigger 166 when actuating the micro switch 182. Wires 188 extend through or along the hose 178 and electrically connect the micro switch 182 to the PCB 110. As shown in FIG. 9, the wand 22 also includes a mechanical valve assembly 190 (FIG. 9) having a valve bore 194, a stopper 198, a plunger 202 extending within the valve bore 194 between the trigger 166 and the stopper 198, and a spring 206 biasing the plunger 202 toward the trigger 166.

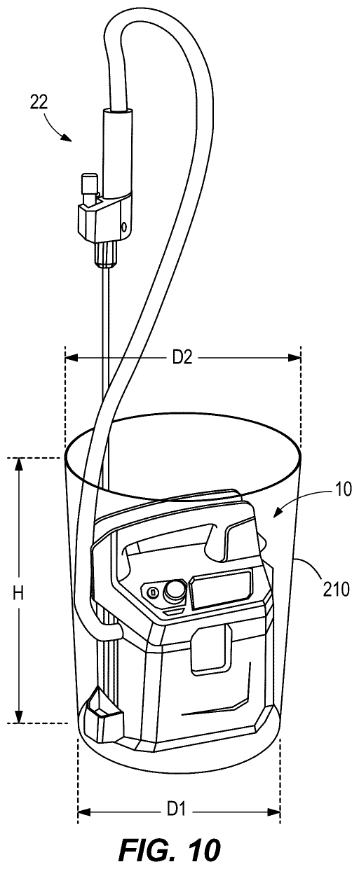

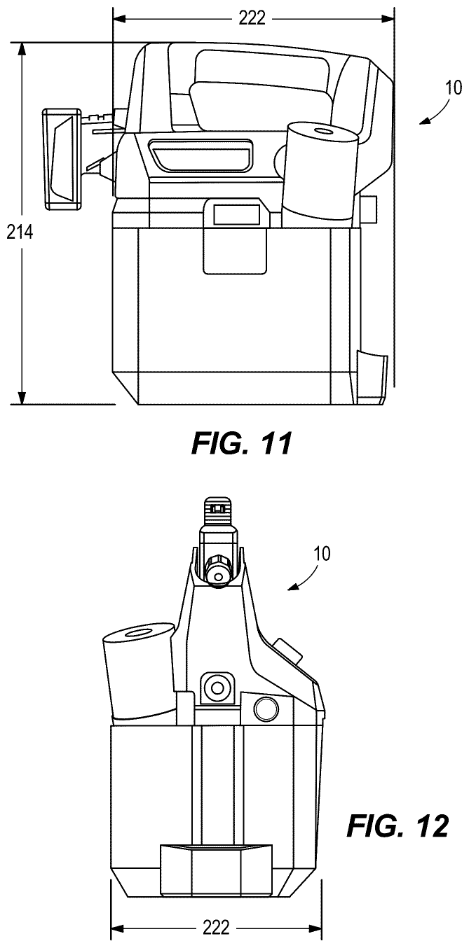

With reference to FIGS. 10-12, the sprayer 10 is advantageously shaped and sized to be able to be accommodated within a standard five-gallon bucket 210. A typical standard five-gallon bucket 210 has a bottom diameter D1 of approximately 260 millimeters, a top diameter D2 of approximately 300 millimeters, and a height H of approximately 360 millimeters. As shown in FIGS. 11 and 12, the sprayer 10 has an overall height 214 measured from the bottom surface 86 to the carrying handle 30, and overall length 218 measured from the first retaining portion 138 to the battery receptacle 42, and an overall width 222 measured from opposing side surfaces of the supply tank assembly 18. The overall height 214 is approximately 300 millimeters to approximately 310 millimeters, and more specifically, 306 millimeters. The overall length 218 is approximately 240 millimeters to approximately 250 millimeters, and more specifically, 242 millimeters. The overall width 222 is approximately 190 millimeters to approximately 200 millimeters, and more specifically, 195 millimeters.

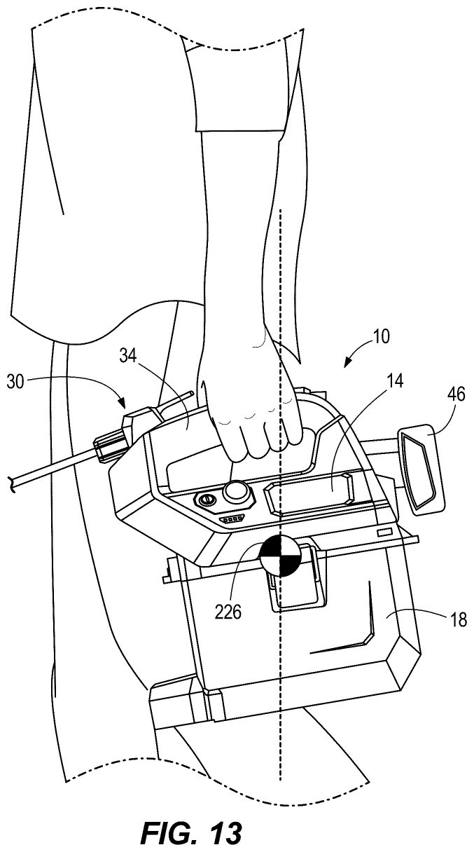

With reference to FIG. 13, the sprayer 10 is capable of being held by a user's hand. Specifically, a user may grasp the gripping region 34 to carry and maneuver the sprayer 10. The sprayer 10 includes a center of gravity 226 that remains within a vertical footprint of the gripping region 34 when the sprayer 10 is being carried. As such, the center of gravity 226 also generally remains aligned a user's hand when a user is carrying the sprayer 10 to avoid torque and strain on a user's wrist.

In operation, when the trigger 166 is depressed, the trigger 166 first actuates the plunger 202 to open the mechanical valve assembly 190 and fluidly connect the hose 178 with the nozzle 170. As the trigger 166 continues to be pivoted toward the wand handle 162, the trigger 166 subsequently engages the lever 186 and actuates the micro switch 182 to activate the motor 102 and begin pumping liquid from the supply tank assembly 18 out the nozzle 170. The mechanical valve assembly 190 opens before the micro switch 182 activates the motor 102, which prevents the pump 106 from building pressure in the hose 178 and thus prevents any undesirable burst or overspray of liquid during operation of the sprayer 10.

Similarly, when the trigger 166 is released, the trigger 166 first disengages the lever 186 to open the micro switch 182, and then disengages the plunger 202 to close the mechanical valve assembly 190. This ensures that the motor 102 is deactivated and the pump 106 stops pumping liquid before the valve assembly 190 closes and thereby prevents pressure from building within the hose 178.

Various features of the invention are set forth in the following claims.

What is claimed is:

1. A portable, battery-powered liquid sprayer, the sprayer comprising:
a supply tank assembly for holding a liquid to be sprayed;
a body assembly selectively coupled to and supported by the supply tank assembly, the body assembly receiving a motor and a pump;
a battery removably coupled to the body assembly and operable to supply power to the motor; and
a wand moveable relative to the body assembly and in fluid communication with the supply tank assembly, the wand including a nozzle;
wherein the wand includes an actuator operable to activate the motor, which drives the pump to pump the liquid from the supply tank assembly and to eject the liquid from the nozzle.

2. The sprayer of claim 1, further comprising a filling channel extending upward from the supply tank assembly such that the supply tank assembly is fillable with the liquid through the filling channel.

3. The sprayer of claim 2, further comprising a measuring cup threadably coupled to the filling channel, wherein the measuring cup is moveable between a first state, in which the measuring cup is coupled to the filling channel to seal an inlet opening of the filling channel, and a second state, in which the measuring cup is uncoupled from the filling channel, and wherein the measuring cup is fillable to measure an amount of liquid to be added into the supply tank.

4. The sprayer of claim 3, wherein the filling channel extends above at least a portion of the body assembly, thereby enabling access to the measuring cup when the supply tank assembly and the body assembly are coupled to each other.

5. The sprayer of claim 1, further comprising an outlet opening disposed on the supply tank assembly, a pickup line extending between the outlet opening and a bottom surface of the supply tank assembly, and a cap threadably secured to the outlet opening, wherein the pickup line is in fluid communication with the pump.

6. The sprayer of claim 1, further comprising a first docking station and a second docking station, each capable of receiving and retaining the wand.

7. The sprayer of claim 6, wherein a nozzle of the wand is positioned within the first docking station to secure the wand in a first storage position, in which the wand is substantially vertical relative to a ground surface.

8. The sprayer of claim 7, wherein the first docking station includes a first retaining portion and a second retaining portion that collectively retain the nozzle of the wand in the first storage position.

9. The sprayer of claim 6, wherein a handle of the wand is positioned within the second docking station to secure the wand in a second storage position, in which the wand is substantially horizontal relative to a ground surface.

10. The sprayer of claim 9, wherein the second docking station includes a concave slot that elastically deforms to selectively secure the handle of the wand in the second storage position.

11. The sprayer of claim 1, further comprising a user interface module having a power button that is operable to electrically connect the battery with a controller and the motor, a power control knob for adjusting a pressure of liquid ejected through the nozzle, and a power level indicator for displaying a remaining charge capacity of the battery.

12. The sprayer of claim 1, wherein the body assembly and the supply tank assembly combine to define an overall height measured from a bottom surface of the supply tank assembly to a carrying handle of the body assembly of approximately 300 millimeters to approximately 310 millimeters.

13. The sprayer of claim 12, wherein the body assembly and the supply tank assembly combine to define an overall length measured from a first docking station to a battery receptacle of approximately 240 millimeters to approximately 250 millimeters.

14. The sprayer of claim 13, wherein the body assembly and the supply tank assembly combine to define an overall width measured from opposing upright side surfaces of the supply tank assembly of approximately 190 millimeters to approximately 200 millimeters.

15. The sprayer of claim 14, wherein the body assembly and the supply tank assembly together are configured to be received within a standard size five-gallon bucket.

16. A portable, battery-powered liquid sprayer, the sprayer comprising:
a supply tank assembly for holding a liquid to be sprayed;
a body assembly coupled to the supply tank assembly, the body assembly including a motor and a pump;
a battery removably coupled to the body assembly and operable to supply power to the motor to drive the pump; and
a wand in fluid communication with the supply tank assembly, the wand including
a nozzle,
a mechanical valve assembly,
a handle,
a micro switch disposed within the handle, and
a trigger movably coupled to the handle,
wherein the trigger is moveable to actuate both the mechanical valve assembly and the micro switch, and
wherein actuation of the micro switch energizes the motor.

17. The sprayer of claim 12, wherein movement of the trigger to an actuated position first actuates the mechanical valve assembly and subsequently actuates the micro switch.

18. The sprayer of claim 13, wherein the mechanical valve assembly is opened when the trigger is actuated to place the nozzle in fluid communication with the pump and the supply tank assembly.

19. The sprayer of claim 16, further comprising a user interface module having a power button that is operable to electrically connect the battery with a controller and the motor, a power control knob for adjusting a pressure of liquid ejected through the nozzle, and a power level indicator for displaying a remaining charge capacity of the battery.

20. A method of storing a portable, battery-powered liquid sprayer in a five-gallon bucket, the method comprising:
maintaining a connection between a body assembly and a supply tank assembly;
removing a battery from the body assembly;
placing a wand in a first docking station that extends between the body assembly and the supply tank assembly, such that the wand is held in a substantially vertical position relative to a ground surface; and
positioning the sprayer in the five-gallon bucket, such that the body assembly and the supply tank assembly are completely encompassed within the bucket, while at least a portion of the wand extends beyond the confines of the bucket.
